(19) United States
(12) Patent Application Publication
(10) Pub. No.: US 2002/0049816 A1
(43) Pub. Date: Apr. 25, 2002

(54) System and method for raising funds and establishing user affinity over a distributed network

(76) Inventors: William Gilmore Costin IV, Bryn Mawr, PA (US); Breckenridge Wilson Kling, New York, NY (US); Jackson W. Barber, San Francisco, CA (US)

Correspondence Address: Kevin T. Duncan, Esq., Hunton & Williams, Suite 1200, 1900 K Street, N.W., Washington, DC, 20006, US

(21) Appl. No.: 09/816,210

(22) Filed: Mar. 26, 2001

Related U.S. Application Data
(60) Provisional application No. 60/191,758, filed on Mar. 24, 2000.

(51) Int. Cl. G06F 17/60; G06F 15/16

(52) U.S. Cl. 709/206; 705/26

(57) ABSTRACT

A fundraising system and method that allows users to raise money from friends and other entities over a distributed network, such as the Internet, is presented. The present invention provides online marketing applications for e-businesses by using the power of viral marketing to enable clients to attract new customers at a lower cost, and build brand loyalty. For example, the fundraising system of the present invention enables e-businesses to partner with causes, such as charitable, non-profit and community organizations, to host fundraising events online with interactive participation by all involved. For example, an e-mail networking component may enable fund-raisers to send out an infinite amount of requests supporting the cause they care about. Thus, for every fund-raiser, the host e-business gets a new flow of visitors to their site.

### FIELD OF THE INVENTION

The invention relates to online fundraising over a distributed network involving interaction among businesses, causes, customers, and/or donors.

### BACKGROUND OF THE INVENTION

Sophisticated companies employ cause marketing which combines advertising and charitable giving by merging their business activity with a relevant cause through advertising, marketing and charitable giving for mutual gain. Benefits to these companies include a heightened emotional connection with customers, employees and the community—and a subsequent positive impact on the business.

Cause marketing is a burgeoning segment as demonstrated by the 328% increase in cause program spending from 1990 to 1997 (Cone/Roper Report 1999). In 1998, corporate America spent $285 billion on marketing and advertising while individuals donated $175 billion to charities in the U.S. The convergence of these two markets represents significant opportunity for an Internet-based Cause Marketing firm such as ours. Today, online fundraising is exploding as recently demonstrated by Presidential candidate John McCain's web site after the New Hampshire primary. In the two weeks following his victory, the campaign site took in $2.5 million in web donations ($15,000 per hour) and signed up 40,000 volunteers.

Very little has been done to harness the compelling forces of online fundraising and cause marketing. The combination of cause marketing's rise and the magnitude of charitable giving indicate an under-served market segment with the potential to benefit advertisers, nonprofit organizations, fund-raisers and donors.

What is needed is a system to service global companies in employing cause marketing as a means to cost effectively enhance brand reputation, acquire customers and contribute to charitable well being.

### SUMMARY OF THE INVENTION

The present invention provides online marketing applications for e-businesses by using the power of viral marketing to enable clients to attract new customers at a lower cost, and build brand loyalty. In the rapidly growing market of cause marketing, the novel fundraising system of the present invention allows e-businesses to partner with causes, such as charitable, non-profit and community organizations, to host fundraising events online with interactive participation by all involved.

The present invention provides a fundraising system and method that allows users to raise money from friends over a distributed network, such as the Internet. The e-mail networking component is especially viral as fund-raisers can send out an infinite amount of requests supporting the cause they care about. Thus, for every fund-raiser, the host e-business gets a new flow of visitors to their site.

In one respect, the process begins when an e-business/sponsor supports a cause, such as a charity or non-profit organization, that is favored by the company's top management or employees - or holds relevance with its customers. In the absence of a pre-existing relationship with a cause, a service employing the fundraising system of the present invention could facilitate one. After establishing a relationship among the benefactor sponsor and the beneficiary organization, an online fundraising campaign is formulated and conducted. For instance, a promotional banner for the campaign may be placed on the e-business home page, such as on the World Wide Web via the Internet or an internal company posting board/page via a LAN or WAN over a closed distributed network or the like.

In one embodiment, users, customers and employees of the e-business visit the e-business web site where they are presented with a link to a campaign web page having the Friend-to-Friend Fundraising System™ of the present invention. In a seamless fashion, the potential donors are transferred from the e-business site to a separate web site maintained by a fundraising service provider where they can learn about the particular cause, donate to the cause, and/or become individual fund-raisers.

In one aspect of the present invention, customers/employees/donors are enabled to become individual fund-raisers, such as by setting up a personalized campaign page and sending e-mails to anyone they choose, including friends, family and colleagues. E-mail recipients are typically provided with a message identifying the person forwarding the email and a message explaining that person's association or experiences with the cause, the sponsor, or some other donor/individual fund-raiser. The email message also typically includes links to the campaign page, where the potential donor may learn about the event and make secure, credit card or other donations or contributions. The email message may also include contact information or links to other sites, such as the e-business/sponsor web site, the cause's web site, the forwarding donor's web site or email address, etc. In this hierarchy, the initial donor/fund-raiser who forwards the email may be referred to as the “primary” donor and the potential donor receiving the email as the “secondary” door, and so forth and so on.

E-businesses/sponsors may also provide incentives by offering prizes and coupons to further motivate fund-raisers and donors. Additionally, the partner cause notifies its donor base about the campaign and encourages them to visit the host site. The visiting donors identify the commercial e-business with the cause, which they already have an affinity for as donors. This helps to engender and solidify a relationship among the e-business/sponsor and the cause's donor base.

The present invention can work in a variety of ways for many different types of organizations. The following are examples of partnering arrangements in which the present invention may be utilized. Linking a sporting goods e-business, such as MVP, to the fundraising needs of national, regional or local little-league baseball associations across the country. Linking an e-business retail service provider, such as Coolsavings.com, to a health related cause, such as the Y-Me National Breast Cancer Foundation. Linking automobile manufacturers, like Ford Motor Company, to a national cause with local chapters, such as Mothers Against Drunk Driving (MADD).

Another example of an implementation of the present invention is powering web-based portals, such as AthletesVillage.com, in which organization-supported events may be linked to a homepage where information covering the event and associated causes may be provided as well as a mechanism for selecting one of several causes and receiving donations therefor and enabling users/donors to conduct personalized fundraising campaigns on behalf of the selected cause(s).

The fundraising application may be used by e-businesses that have groups, such as employees or customers, that would like to raise money for one or more causes. There are thousands of e-businesses that aggregate people in this way including portals, vertical portals, community sites and academic institutions. Inter-company or even intra-company campaigns may be organized and managed by the fundraising service provider. Participating companies may assign benefits to a set of goals associated with the efficacy of the campaign or an individual's efforts.

It may also be necessary to implement particular operational requirements for professional fundraising, such as state registration, bonding, merchant account and donation accounts. State laws and regulations vary greatly and require a detailed understanding of all regulatory issues. The service provider conducting the campaign on behalf of a business/sponsor or cause should ensure full compliance with all fundraising laws. This infrastructure enables efficient and proper reporting, money collection and distribution. Aspects of the fundraising system include:

Private label—This enables e-businesses to seamlessly host fund raising campaigns on their site using our technology and servers. In the alternative, a cause, powered by the fundraising technology of the present invention, could internally manage hosted fundraising campaigns. This may be especially attractive to larger organizations.

Customized Campaigns—enabling E-businesses to design and develop their own campaigns and allowing customization to ensure optimal effectiveness.

Online Donations—Application of servers and encryption technology in fundraising campaigns to collect credit card donations for causes in an effective, secure and efficient manner. Typically, donations reside in a trust account and are dispersed bi-weekly to the respective organizations.

Friend-to-Friend Fundraising™—In one manner, after a business-sponsor or cause sets up a campaign page, a general message is forwarded to potential donors/customers based on a collection of e-mail addresses of “secondary” donor prospects. The system personalizes each message and keeps only the recipient's name on the address line. Upon receiving the e-mail, the potential donor can, among other things, connect to the site, make a donation and get a receipt in a few minutes. The system perpetuates itself in a viral manner when those solicited become “primary” donor fund-raisers themselves and start the process over again.

The fundraising system of the present invention is a valuable tool for building brand awareness, increasing traffic and acquiring customers. The ubiquity of Internet marketing has made it increasingly challenging to make an impression while advertising costs continue to soar. One aspect of the present invention provides the ability to localize a brand into a community within a specific demographic. Moreover, users of the system promote the host business to their friends, family, and colleagues when fundraising.

Because of the enhanced credibility of being recommended by a friend, family member or colleague, response rates are enhanced, e.g., surpassing 60%, and will greatly exceed current direct mail and e-mail marketing figures. The table below relates the metrics of a 100,000 piece mailing, with an average sales of $100 per conversion.

| | | | | Friend-to- |
|---|---|---|---|---|
| | Direct | | | Friend |
| | Marketing | Banner Ads | Direct Mail | System |
| Total Cost Per Piece | $0.25 | $0.05 | $1.20 | $.30 |
| Response Rate | 7.5% | 1.0% | 1.0% | 60% |
| Conversion | 10% | 10% | 10% | 5% |
| Results | | | | |
| Total Program Costs | $25,000 | $5,000 | $120,000 | $30,000 |
| Number Responding | 7,500 | 1,000 | 1,000 | 60,000 |
| Cost Per Response | $3.33 | $5.00 | $120.00 | $.50 |
| Number Converting | 750 | 100 | 100 | 3,000 |
| Cost Per Conversion | $33.33 | $50.00 | $1,200.00 | $10.00 |
| ROI | $50,000 | $5,000 | ($110,000) | $270,000 |
| ROI % | 200% | 100% | −92% | 900% |

Systems currently in place fail to adequately and effectively bridge the gap between Internet marketing and fundraising. Examples of known donation portals are CharitableWay and Helping.org. Also, companies such as SchoolPop, Shop2Give, CharityWeb, iGive and 4Charity host Internet shopping mall sites and make donations to causes when customers browse and shop online. Online advertisers include DoubleClick, YesMail, NetCreations and others.

The fundraising system of the present invention increases returns driven by network economics and gains leverage with every new addition. This takes place as clients build a network of charities under a common cause, such as nationwide associations of little league baseball teams. The more these networks grow, the greater the efficacy of the underlying system. This is then realized by leveraging these networks in a variety of complementary programs.

The system is highlighted with the following characteristics:

Low, fixed-cost expense structure with minimal variable costs.

Scalable technology that is easily adaptable on multiple business platforms.

High margins.

Multiple revenue streams.

Revenues may be generated by, among other things:

1. Licensing fees.

2. Set up fees.

3. Lead fees from new users connecting to the host site from e-mail.

4. A 5% of donations fee charged to collect and disperse funds to the non-profit organization.

5. E-mail advertising fees based on impressions, response rates and transactions.

6. E-commerce fees based on campaign special offerings.

7. Traditional agency fees from marketing initiatives.

Although much of the discussion herein focuses on an Internet or hybrid Internet/LAN implementation of the present invention, it should be understood that the invention is not limited to such implementations and may be utilized in any distributed network architecture, including wired, wireless and a combination of wired and wireless technologies.

### BRIEF DESCRIPTION OF THE DRAWINGS

FIG. 1 is a schematic diagram of an Internet-enabled system employing the fundraising method and system of the present invention;

FIG. 2 is a screen shot of a sample fundraising campaign selection page at a host e-business web site;

FIG. 3 is a screen shot of a selected fundraising campaign page associated with the campaign page of FIG. 2;

FIG. 4 is a screen shot of a sample of fundraising sign-up page at a fund-raiser campaign service provider web site linked to the host campaign web page of FIG. 3;

FIG. 5 is a screen shot of a sample donation form associated with the campaign of FIG. 3;

FIG. 6 is a screen shot of a campaign statistics page associated with the campaign of FIG. 3;

FIG. 7 is a screen shot of a second fundraising campaign hosted by an e-business at a web site;

FIG. 8 is a screen shot of an event page associated with the cause that is the subject of the campaign of FIG. 7;

FIG. 9 is a screen shot of a fund-raiser sign up page at a fund-raiser campaign service provider web site linked to the host web site of FIG. 7;

FIG. 10 is a screen shot of the sign up page of FIG. 9 with the fund-raiser personal profile and contacts fields completed;

FIG. 11 is a screen shot of a donation form associated with the fundraising campaign of FIG. 7;

FIG. 12 is a screen shot of a campaign statistics page associated with the fundraising campaign of FIG. 7;

FIG. 13 is a screen shot of a user information page associated with the fundraising campaign of FIG. 7;

FIG. 14 is a screen shot of a first portion of a FAQ page associated with the fundraising campaign of FIG. 7;

FIG. 15 is a screen shot of a second portion of a FAQ associated with the fundraising campaign of FIG. 7;

FIG. 16 is a screen shot of a third portion of a FAQ page associated with the fundraising campaign of FIG. 7;

FIG. 17 is a screen shot of a cause description and link page associated with the fundraising campaign of FIG. 7;

FIG. 18 is a sample electronic-mail message used in the fundraising campaign system and method of FIG. 1;

FIG. 19 is a flow chart illustrating the fundraising campaign process of one embodiment of the present invention;

FIG. 20 is a screen shot of a fundraising service provider web site;

FIG. 21 is a schematic website and webpage flow diagram for a first fundraising campaign program of the present invention;

FIG. 22 is a schematic website and webpage flow diagram for a second fundraising campaign program of the present invention; and

FIG. 23 is a schematic website and webpage flow diagram for a third fundraising campaign program of the present invention.

### DETAILED DESCRIPTION OF THE PRESENT INVENTION

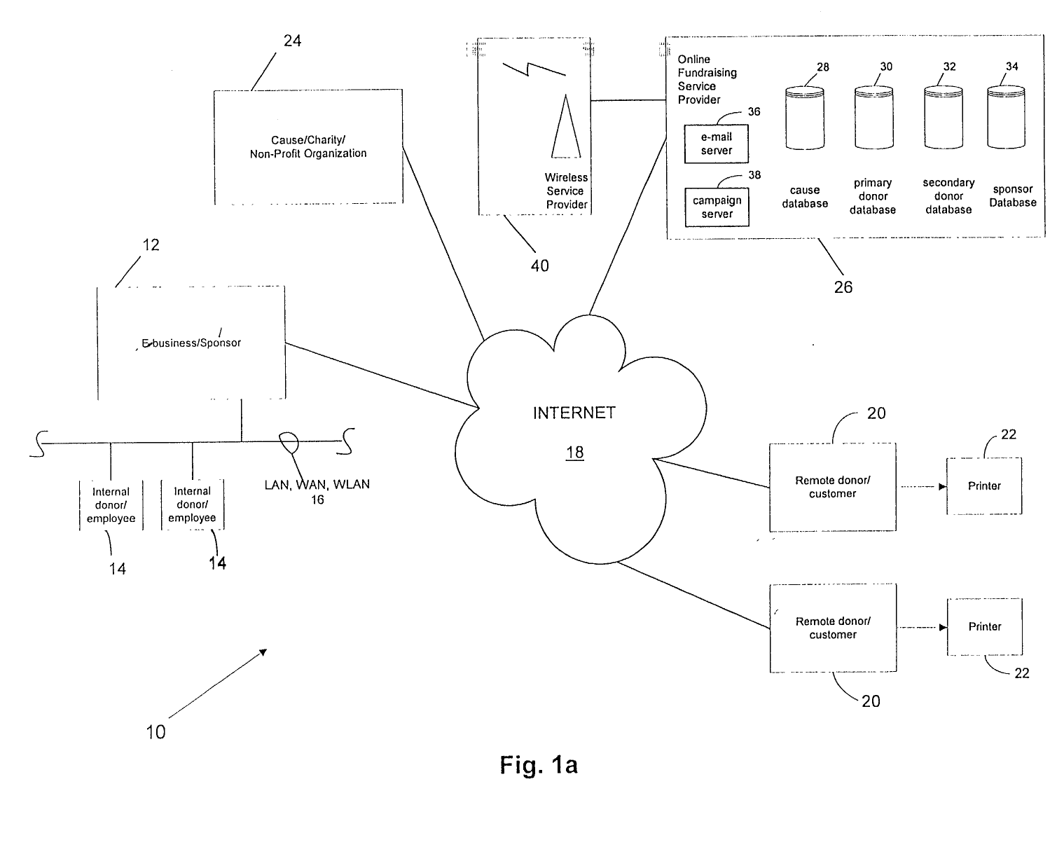

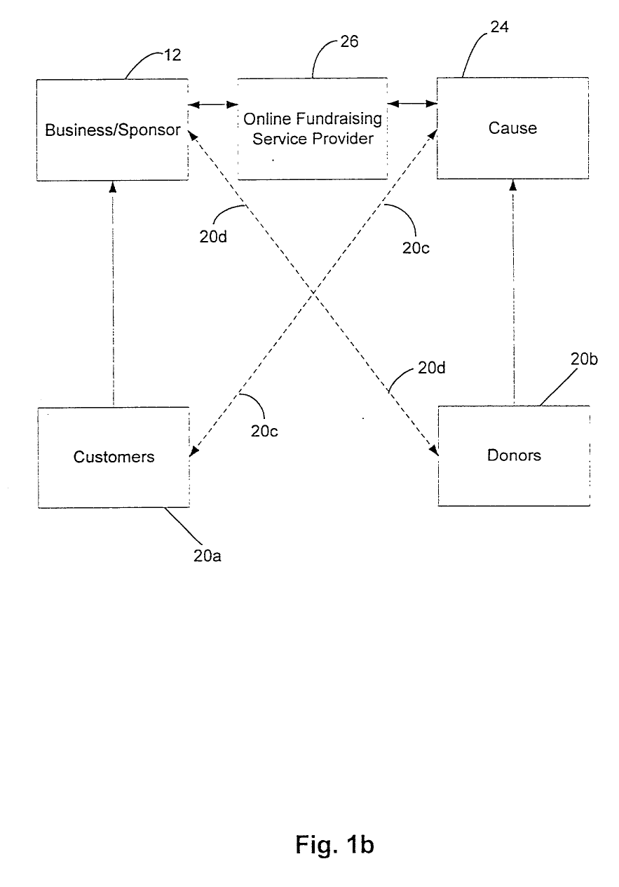

Referring to FIG. 1, a distributed network architecture, generally referenced by reference numeral 10, is shown which implements the system and method for raising funds and establishing user affinity with businesses/sponsors of the present invention. In the distributed network 10, a business/sponsor 12, such as an e-business doing commerce over the Internet, includes a distributed network of internal processors 14 in communication over a network 16, such as a local area network, wide area network, etc. Typically the sponsor 12 is an entity which conducts business or other dealings at least in part over a communications network, such as the Internet 18 and has a web site, such as via the World Wide Web, that is accessible by customers, suppliers, and others, such as by remote PC-based computers capable of connecting to the network 18. Connected to the remote processors of remote customers 20 are printers 22 for printing, among other things, documents associated with the fundraising campaign system of the present invention.

Typically, remote customers 20 access a business web site and browse for goods, services, or content of interest. Upon identifying an item of interest, the user may consummate a commercial transaction in an online fashion, including ordering and paying for the item of interest. As opposed to physically traveling to a bricks and mortar location of a business and shopping in a traditional sense by walking through aisles of displayed goods, it is far easier for online customers to simply key in a different business web address or perform an online search for merchants dealing in the item of interest and to quickly connect to that competing site and thereby become disconnected from the business 12 web site. Businesses employ a variety of measures to peak the interest of remote users 20 and to increase user affinity with the business to solidify the relationship between merchant and customer.

Also connected to network 18 are a variety of causes 24, including charities and other non-profit organizations, that span a broad spectrum of size, purpose, geographic location, public interest, and public recognition. As a fundamental source of monetary support, many causes rely heavily upon donors, such as remote donors 20, to fund the cause organization and activities directed to further the cause in local, national, regional and world wide efforts. Another primary source of funding of many causes are corporate sponsors, such as sponsor 12, and employees of such sponsors, such as employees 14. Increasingly, causes are establishing a sophisticated online presence to disseminate information concerning the cause to educate visitors to a variety of aspects concerning the cause and to provide a real time, convenient means for presenting donors with donation opportunities and to consummate transactions with such donors. Rather than having to accept pledges and rely on donors to remember to write and forward checks and to track donor's pledges from time of pledge to time of receipt, typically via the mail, an online transaction between a donor and a cause is instantaneous, easier to track, and funds typically are received immediately via a credit transaction. Further, the online connection between a donor and a cause provides an opportunity to receive a variety of detailed personal information concerning each donor and to analyze and process the information to arrive at a collective overarching targeting and marketing strategy to increase the efficacy of the causes fundraising, education and mission efforts.

An online fundraising service provider 26 is likewise connected to network 18 and includes, among other things, a cause database 28, a primary donor database 30, a secondary donor database 32, and a sponsor database 34. Databases 28, 30, 32 and 34 may be combined into one database or may be split into a plurality of databases as desired and may be in the form of a relational database and may be associated with various data mining technologies including query-based applications and the like for providing powerful data processing capabilities. Fundraising service provider 26 also includes an email server 36 and a campaign server 38, which are typically processors dedicated to performing specific functions such as providing interconnectivity and processing of email communication between the fundraising service provider 26 and another entity. To further enhance the communication capabilities of the fundraising service, service provider 26 may be connected to a wireless service provider 40 for delivering or receiving messages related to a fundraising campaign in a wireless fashion. Increasingly, wireless connectivity is becoming widely adopted and in many instances is the primary or sole means of communication for discrete networks such as a wireless local area network 16.

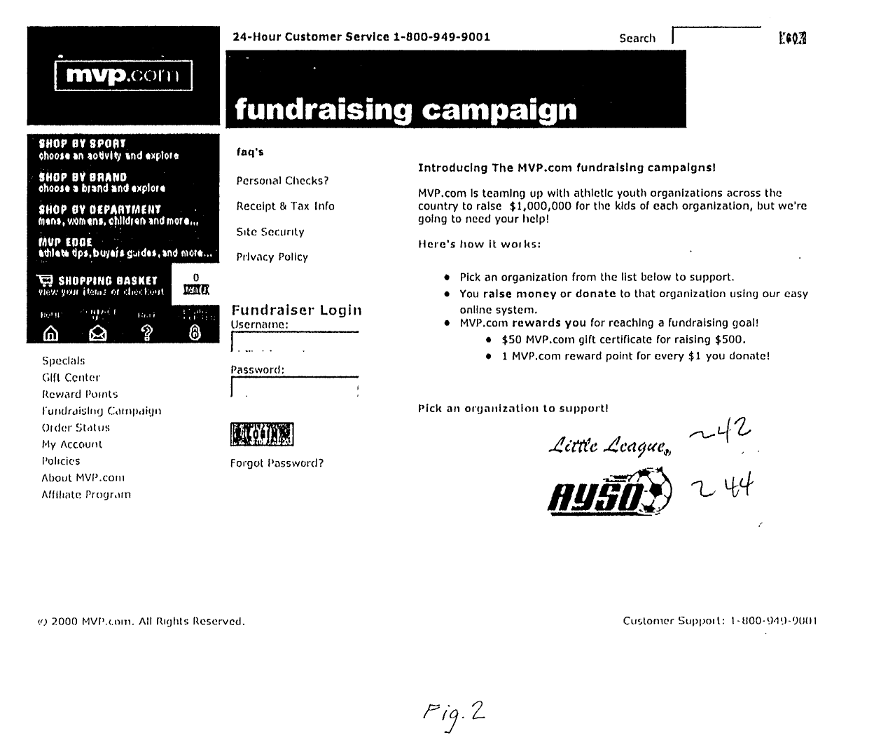

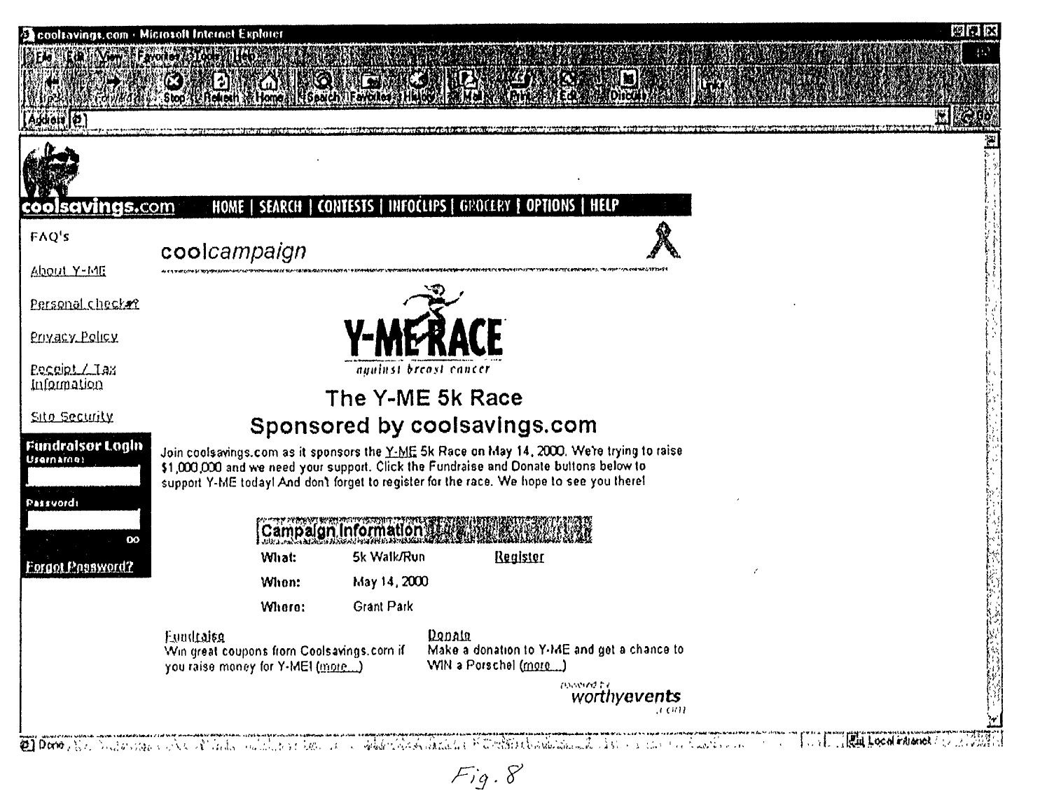

Fundraising service provider 26 facilitates joining causes 24 with sponsors 12 in a variety of ways, including having a sponsor 12 host an online fundraising campaign associated with and for the benefit of a cause 24. In one manner, a host sponsor 12 maintains a web site over the World Wide Web which is accessible by remote customers 20 via the Internet 18. One or more web pages at the sponsor site may be dedicated to a fundraising campaign having an online component that is accessible by customers or others visiting the sponsor's web site. For example, a sponsor's homepage is provided with a link to a fundraising campaign page, as illustrated in FIGS. 2 and 8, where customers/potential donors are introduced to the fundraising campaign.

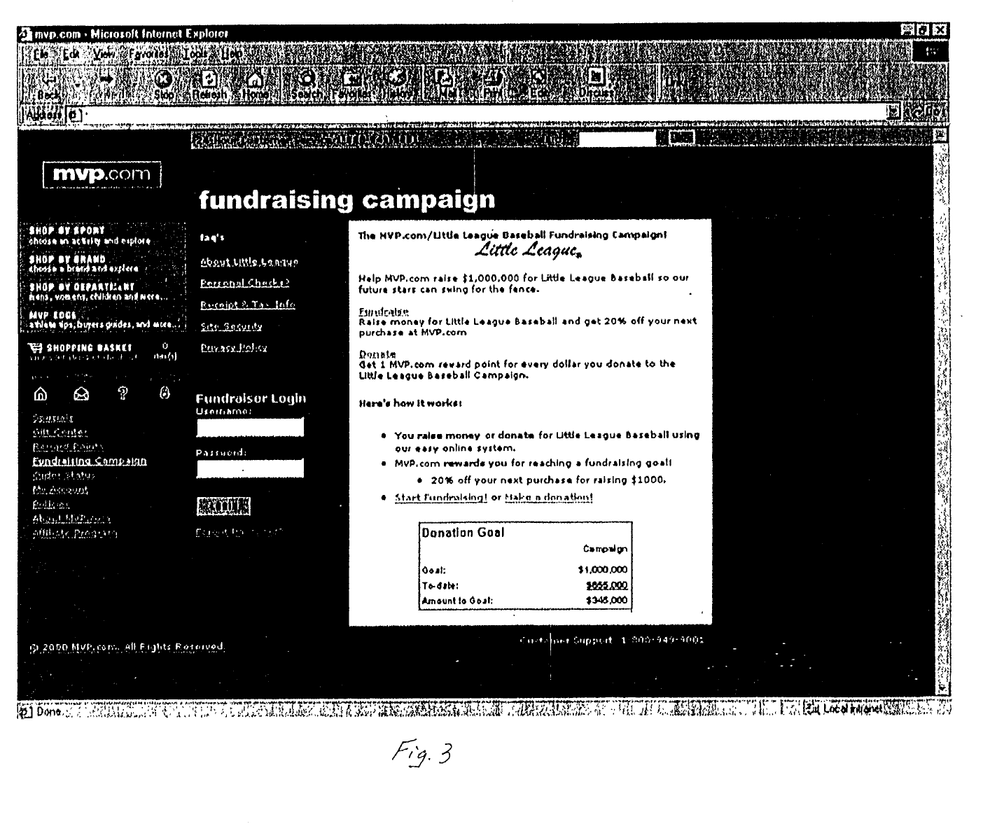

As shown in FIG. 2, host/sponsor MVP.com hosts two fundraising campaigns, Little League baseball campaign and American Youth Soccer campaign, associated with two organizations, Little League baseball and American Youth Soccer organization, respectively. A button or the like connects the user to a selected organization or cause to which the user is interested in supporting or learning more about the particular campaign. Upon selecting the Little League button of FIG. 2, the user is directed toward a web page as illustrated in FIG. 3 having the appearance of the host web site. In one manner, by depressing the cause selection button 42, the user is linked to the web page of FIG. 3 which is maintained by the fundraising service provider 26 over the campaign server 38, as opposed to servers supporting the web site of the sponsor 12. In the alternative, however, the software and architecture associated with operating the fundraising campaign web page may be internal to the sponsor 12 or cause 24. By seamlessly connecting the user to the fundraising campaign web page maintained by the fundraising service provider 26, the user is exposed to logos, advertising, content and links of the host sponsor throughout the fundraising campaign content.

The chart of FIG. 1b illustrates a typical flow of interaction in the online fundraising system described herein. Traditionally, customers 20a visit web sites of businesses 12 to view goods or services offered by such businesses. Also, donors 20b having an interest in a particular cause 24 visit the web site of cause 24 to learn more about the cause and/or to make donations to the cause. By using the online fundraising campaign system described herein, a host sponsor 12 exposes its customers 20a to a particular cause 24 at the sponsor web site. Some of customers 20a will be moved to make or consider making donations to cause 24 which may be carried out, as described herein, via online fundraising service provider 26. Likewise, donors 20b having visited the web site of cause 24 will become informed of the association between the cause 24 and the sponsor 12 and may be moved to visit the sponsor web site where such donors will become exposed to goods and services offered by the business 12. In this manner, the online fundraising system of the present invention establishes a connection between customers 20a and cause 24, as shown by hatched line 20c and donors 20b will establish an affinity with business 12 as illustrated by hatched line 20d. This method of using a fundraising program and affiliating a business/sponsor with a cause to achieve this may be referred to as the “Participatory Marketing” method.

As shown in the illustration of FIG. 3, incentives such as discounts, coupons, tickets, merchandise, etc. may be provided to a customer/donor in exchange for or in association with a donation or other contribution provided by the customer/donor. Also, particular rewards or incentives may be associated with customers/donors becoming fund-raisers for a particular cause in conjunction with the fundraising campaign of the host. In this manner, the customer/donor/fund-raiser receives incentives which may be graduated based upon attaining pre-defined or collectively defined threshold levels or goals. Such incentives may be associated on an individual basis or collectively with groups of individuals or companies serving as discrete fund-raisers.

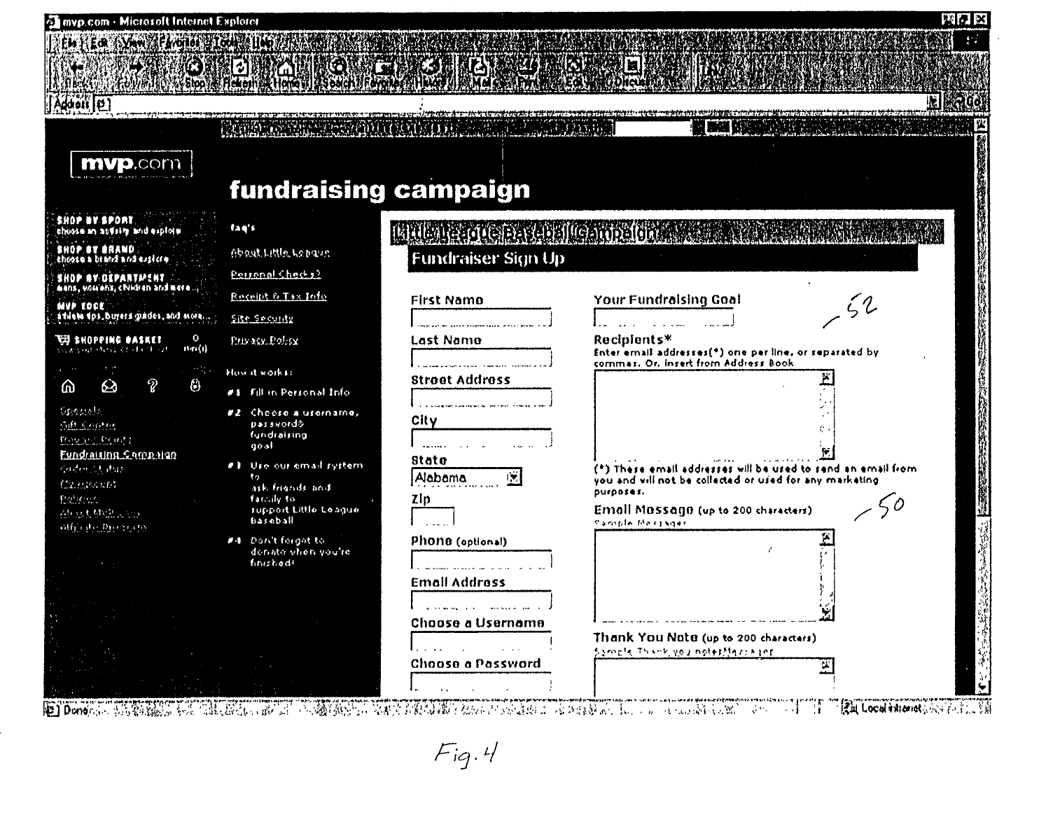

FIG. 4 illustrates a typical fund-raiser sign-up page where the fund-raiser is presented with a questionnaire comprising a series of fields for obtaining information associated with the individual fund-raiser or in the alternative a group or organization that collectively functions as a fund-raiser. The fields illustrated in FIG. 4 are only exemplary and any number of additional fields may be added to obtain particular information associated with the fund-raiser.

One aspect of the present invention relates to fund-raiser message field 50 and fund-raiser recipient field 52. In becoming a fund-raiser, a user drafts a message which may, among other things, do one or more of the following: introduce the fund-raiser, introduce the cause, describe a relationship between the user and the host sponsor, provide links to the cause, host sponsor, fundraising campaign web page, or other links of interest, and state an amount which the fund-raiser may have pledged, contributed or otherwise become committed to and request that the recipient also contribute to the cause. Fundraising campaign service provider 26 may provide a simple message, sample message format, or menu of options associated with drafting an email message for use by the fund-raiser. The fund-raiser provides contact information, such as email addresses, telephone numbers, street addresses, etc., for an identified group of recipients who are to receive the fund-raiser's message composed in field 50.

Recipient field 52 may be adapted to receive information from typical personal organizer-related software, such as contact information from an electronic address book, to facilitate entry of information by the fund-raiser. The fund-raiser email message may be presented in a more structured format where the fund-raiser merely needs to enter particular information in small discrete fields with the overall theme and message being provided by the fundraising service provider, host, or cause. To prevent undesired misuse of the fund-raiser messaging system, the fundraising campaign service provider, host, or cause may monitor, such as through the implementation of content screening software, information provided by the fund-raiser to ensure that offensive and otherwise improper messages are not forwarded to a group of email recipients resulting in a poor reflection on the host and cause.

The fundraising campaign service provider 26 employs tracking and analysis software to manage and enhance the fundraising campaign. For example, a primary fund-raiser may forward messages to a group of recipients with some of the recipients becoming donors and some other recipients becoming secondary fund-raisers. The secondary fund-raisers may then send messages to a second group of recipients with some of the second group of recipients becoming donors and some of the second group of recipients becoming tertiary fund-raisers. Somewhat akin to a chain letter campaign, this viral progression can branch off in a highly escalating manner. One feature of the fundraising campaign system is the ability to track and associate contributions, donations and fund-raisers associated with each of the primary, secondary, tertiary, etc. fund-raisers so that incentives or other form of credit may be attributed to individuals associated with fundraising. Any other number of methods may be employed to establish threshold levels and varying attributes of contributions to arrive at an incentive program designed to encourage participation in the fundraising campaign. Further, analysis tools may be utilized to enhance the incentives program based upon historical trending associated with one or more fundraising campaigns.

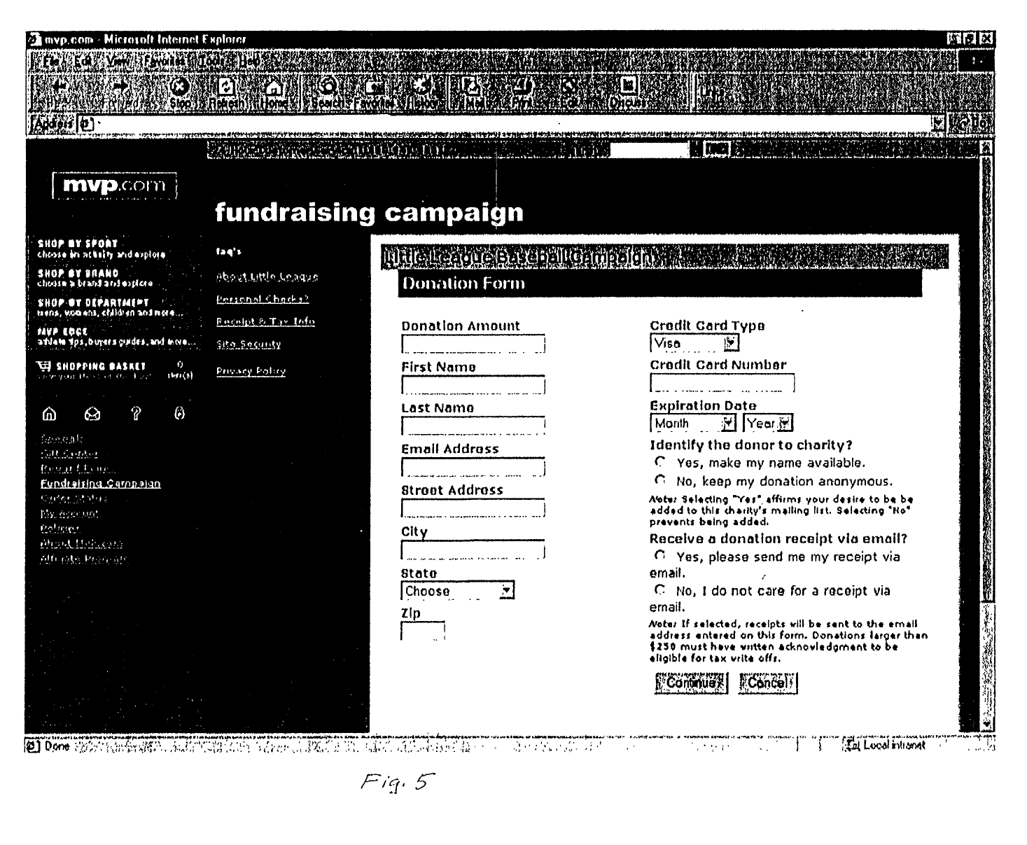

FIG. 5 illustrates a typical fundraising campaign donation form including a number of fields to identify the donor and a payment module for accepting, verifying and completing a secured donation transaction. Further, a donation receipt, such as for tax reporting purposes or the like, may be enabled directly to the user's PC for printing at a remote user printer or may be sent by email, regular mail or other methods to the donor as desired.

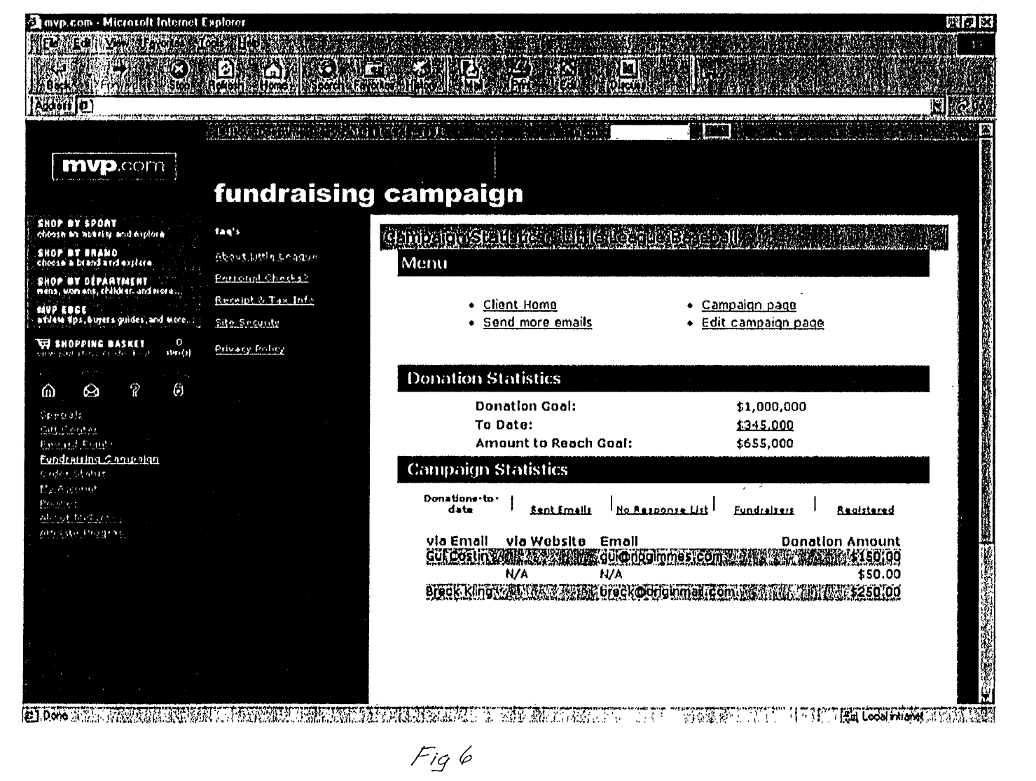

FIG. 6 illustrates a typical campaign statistics page comprising a variety of links to related pages and presenting the viewer with statistics related to the fundraising campaign. In addition, a number of funds may be provided to link the user to content or pages of interest, such as a page dedicated to receipt and tax information, site security, payment methods, privacy policy, cause description, etc.

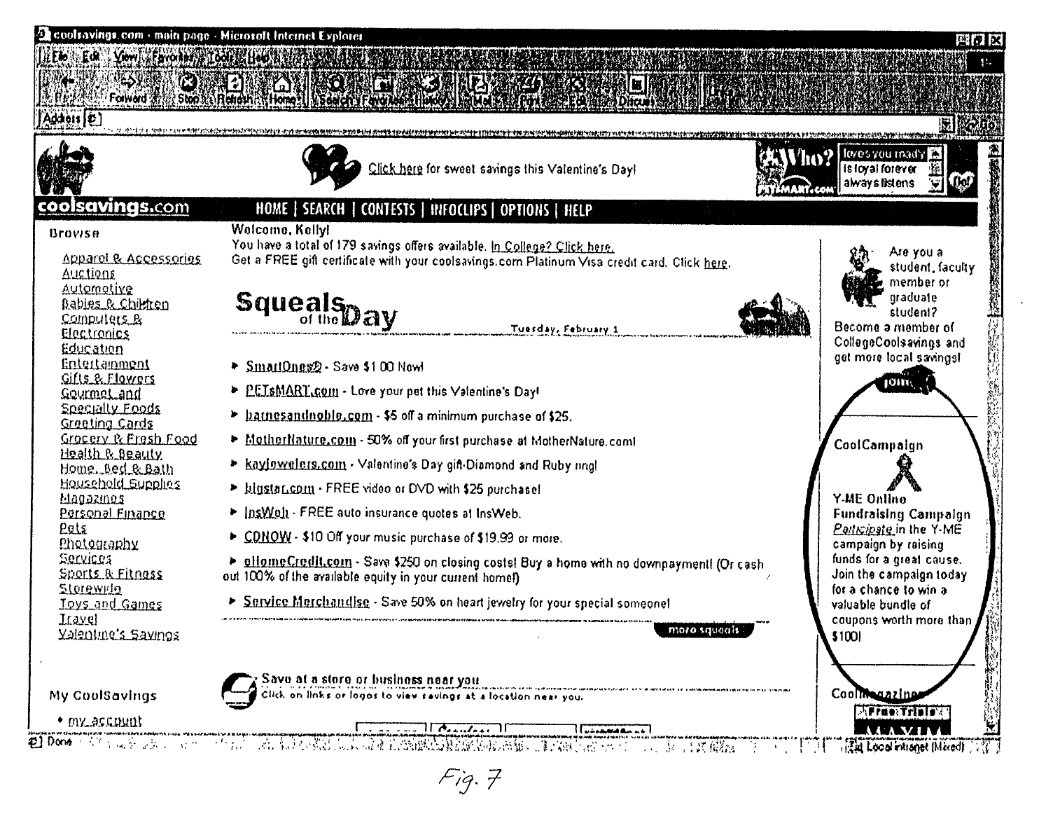

FIG. 7 illustrates a second example of a hosted fundraising campaign where a host web site includes a link and brief description of the hosted fundraising campaign. The host site may include one or more internal web pages dedicated to the fundraising campaign and which link the user to the fundraising campaign service provider 26 for particular functions.

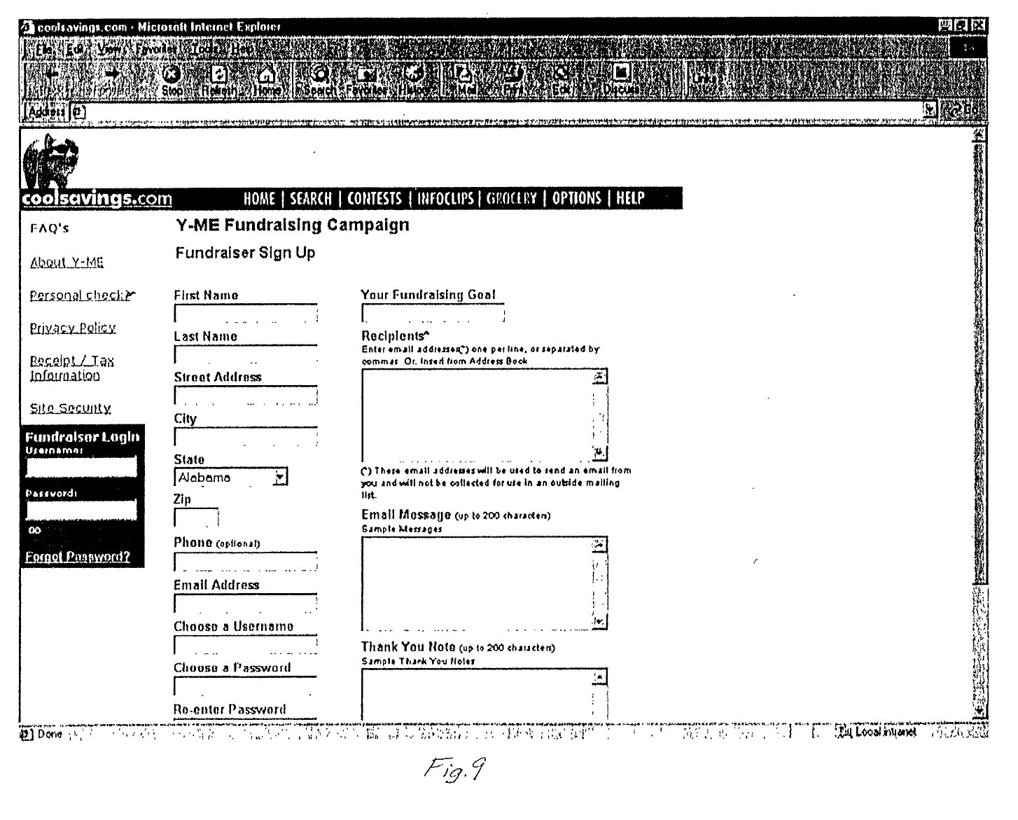

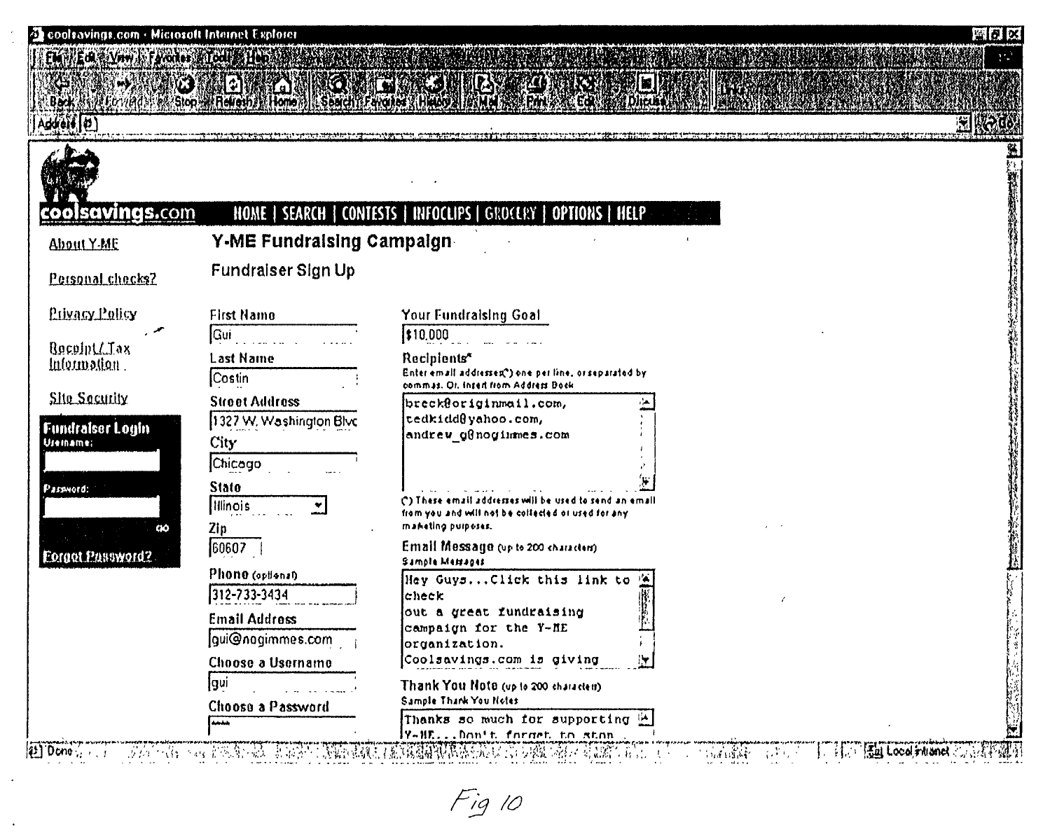

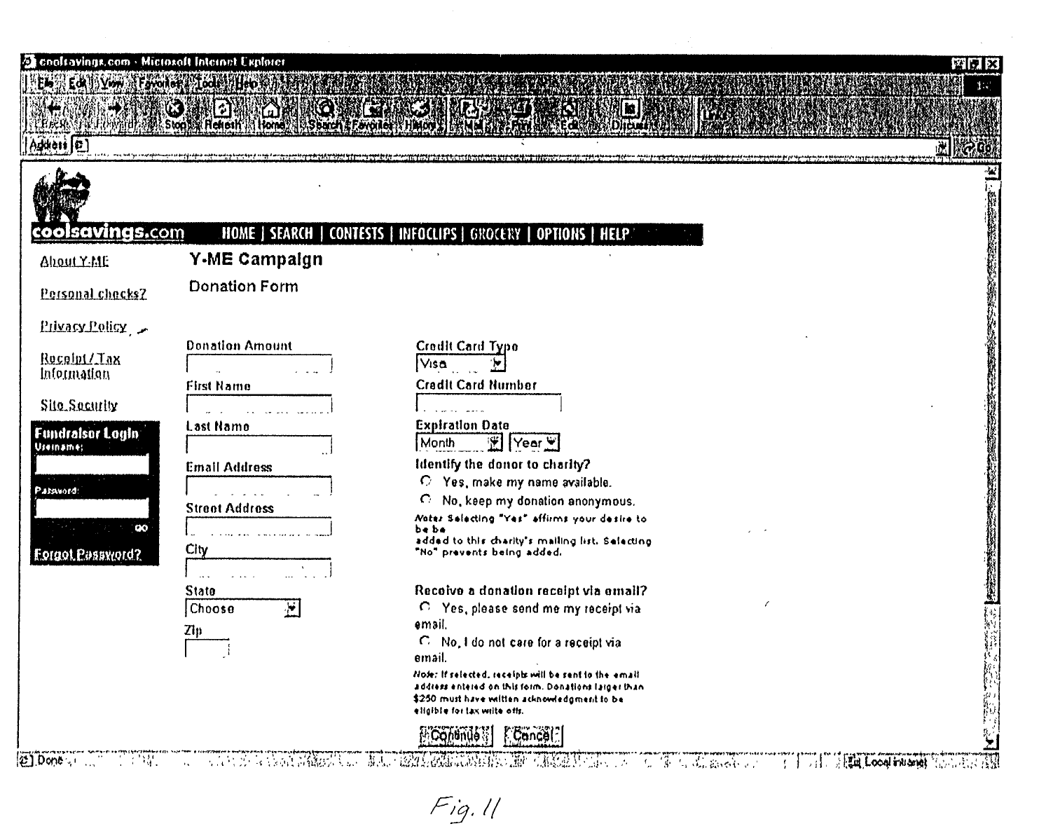

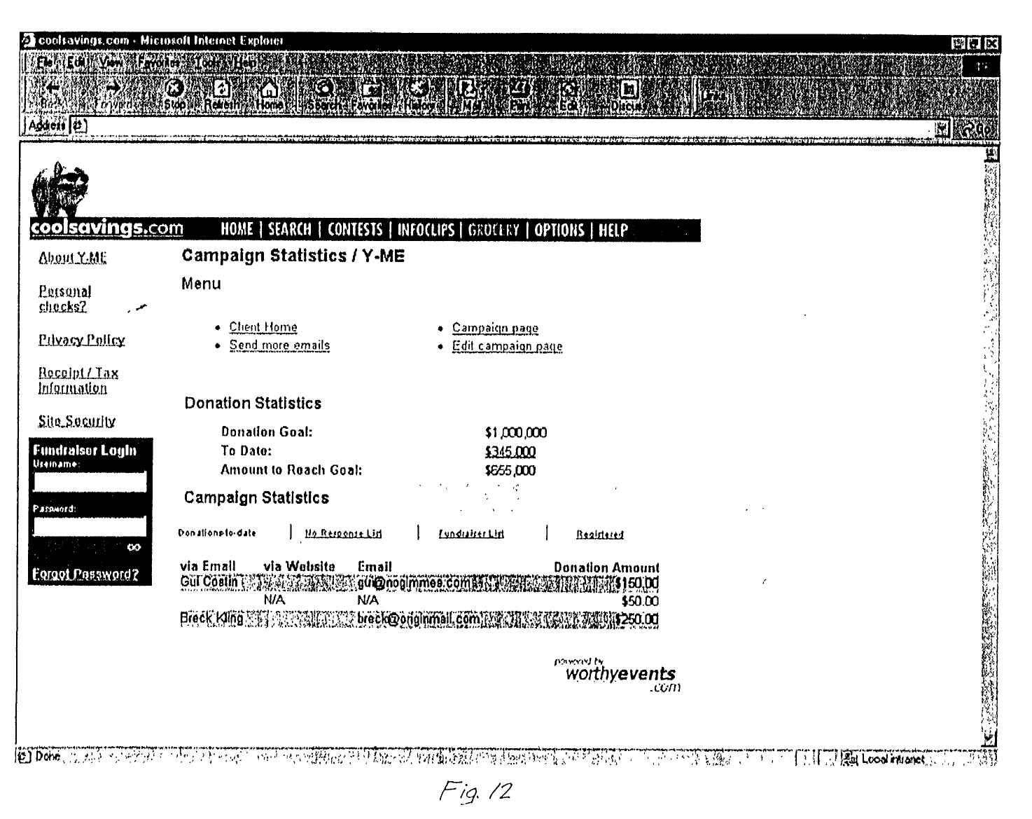

FIGS. 8-12 are examples of web pages, types of content, links, functionality, and other operations associated with fundraising campaign system 10 of FIG. 1a.

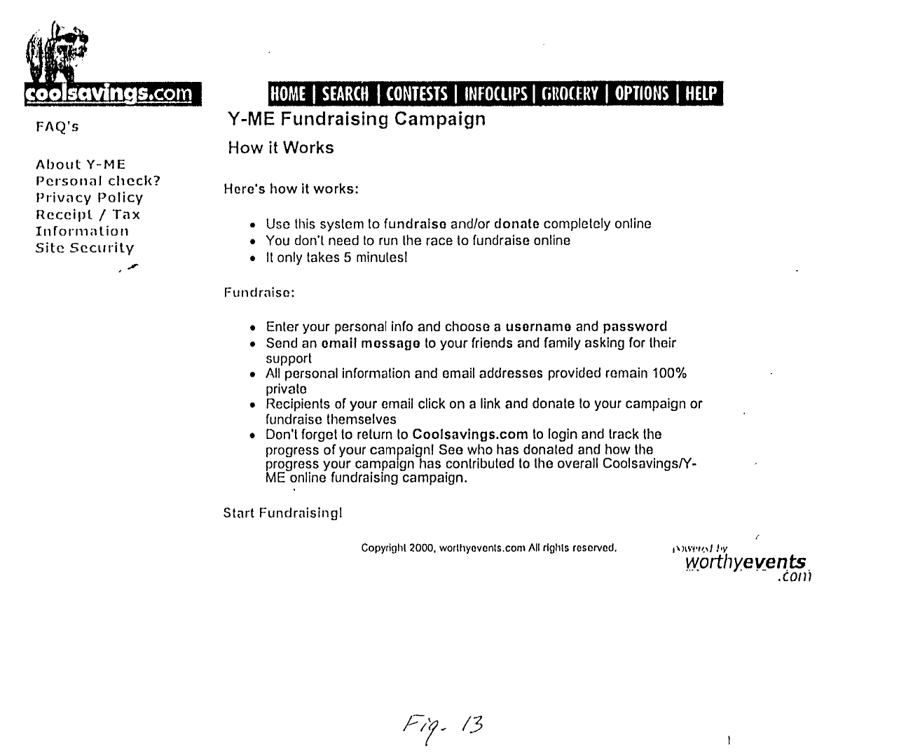

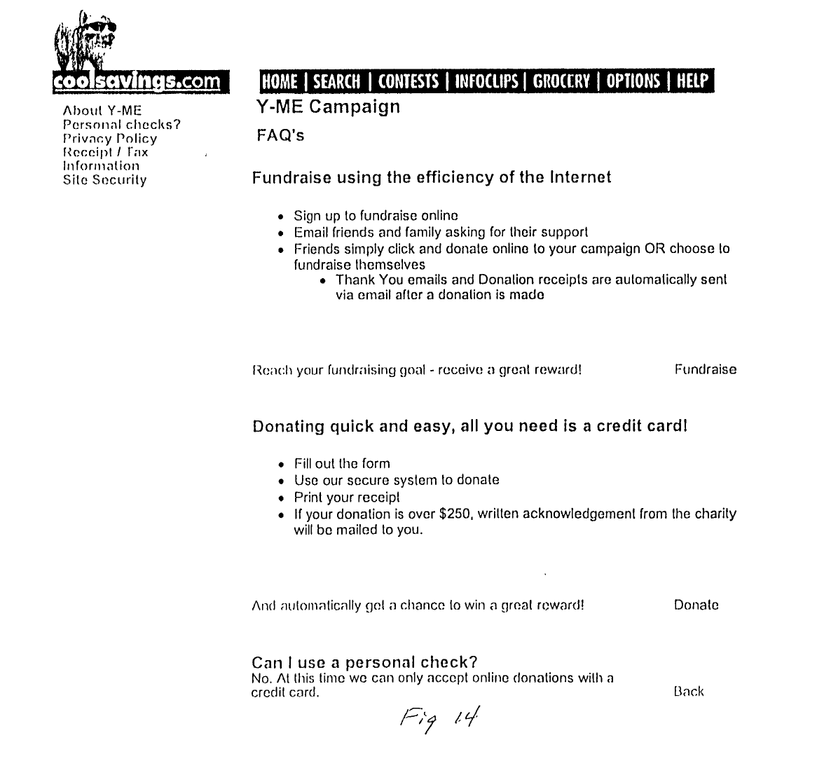

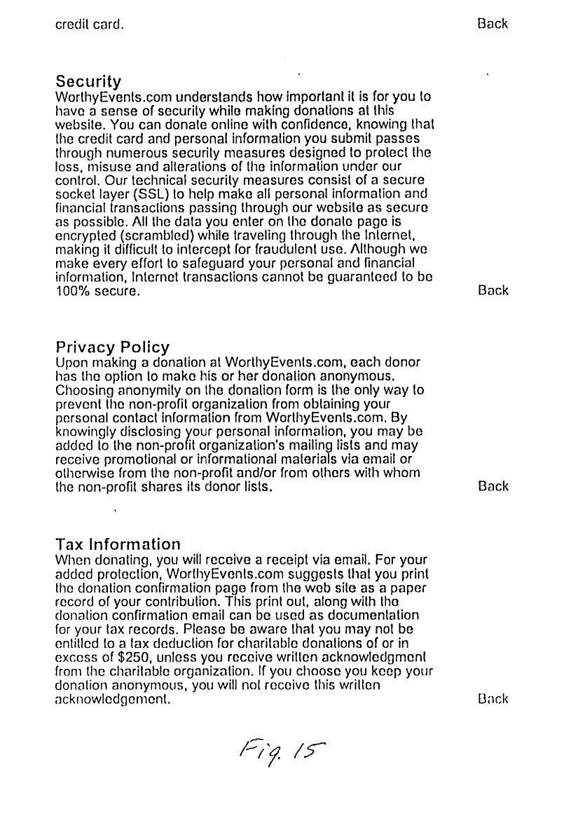

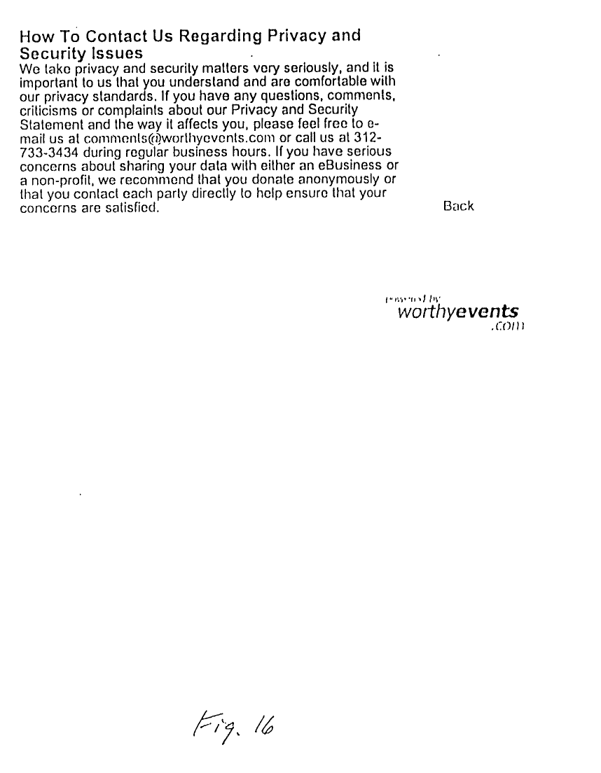

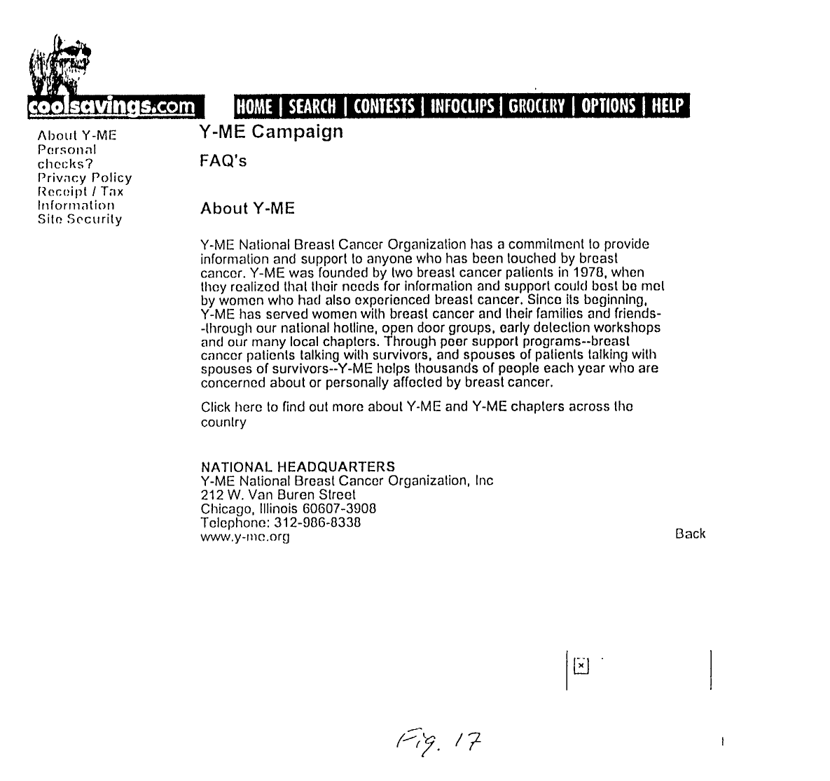

FIGS. 13-17 further illustrate the functionality, content, operation and benefits associated with a fundraising campaign method and system described herein.

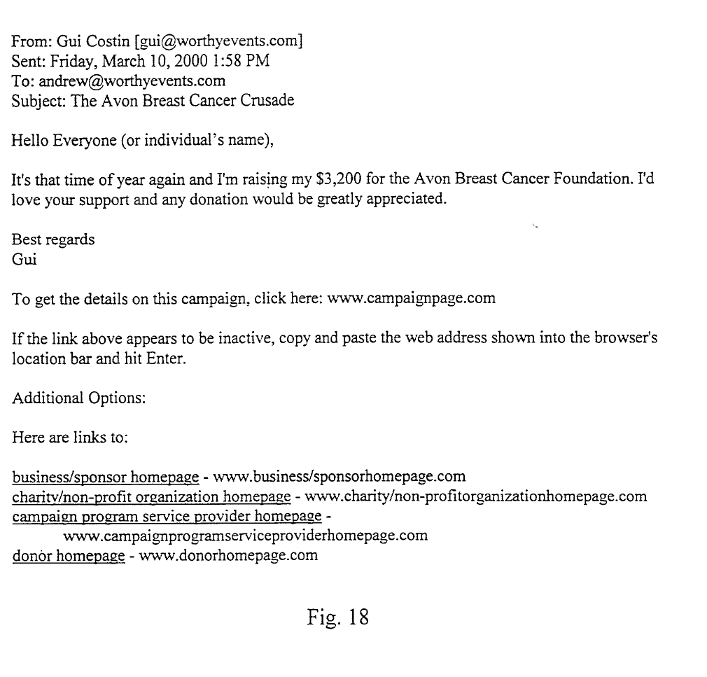

FIG. 18 is an example of a fund-raiser message, for example, in the form of an electronic mail message, received by recipient/prospective donor from a fund-raiser in conjunction with completing a fund-raiser sign-up questionnaire as illustrated in FIGS. 4, 9 and 10, and implemented over the fundraising campaign architecture 10 of FIG. 1a.

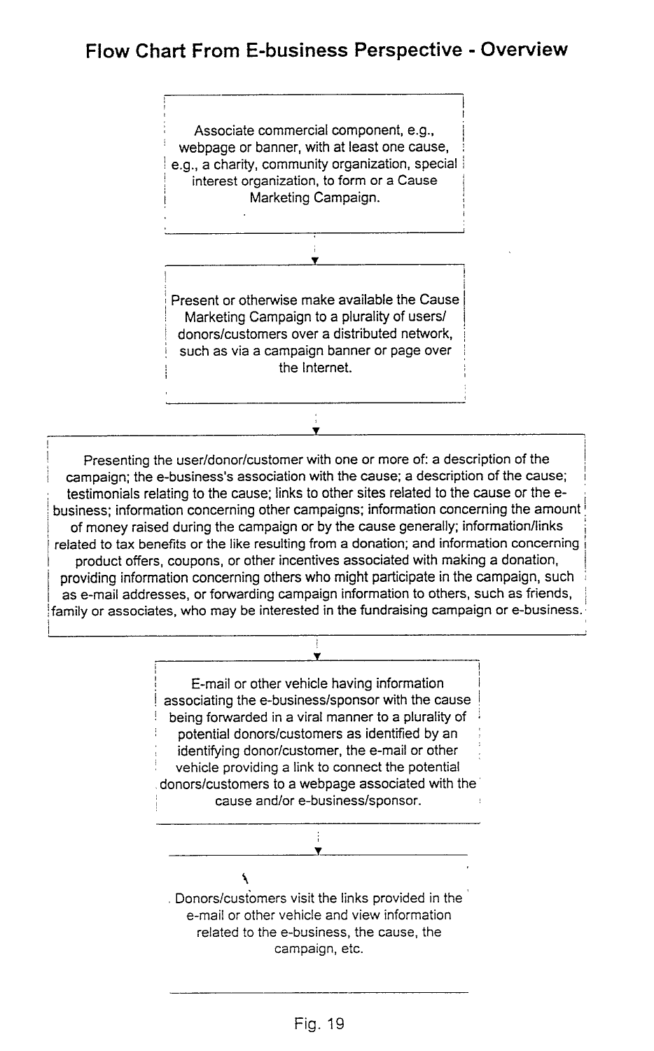

The flowchart of FIG. 19 represents the process of associating a host commercial entity with a cause to form a cause marketing campaign and describes one manner of implementing such a campaign and features, functionality and benefits associated with the campaign.

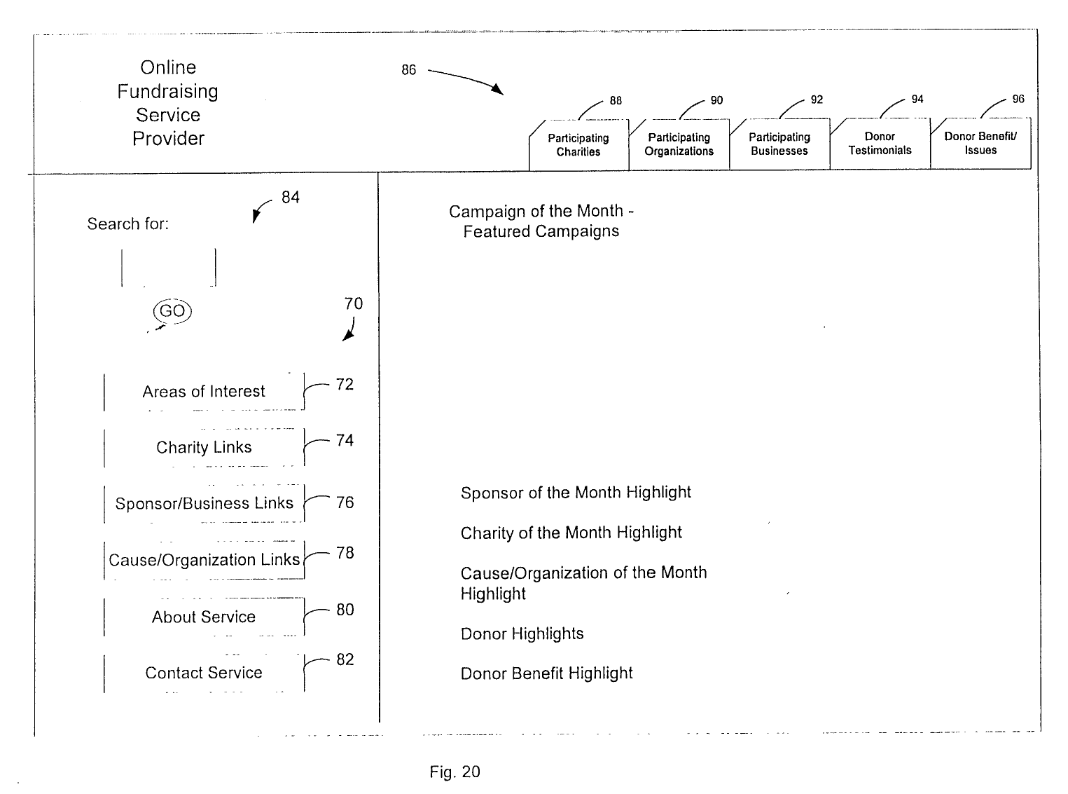

FIG. 20 illustrates a screen shot of one embodiment of a web page maintained by online fundraising service provider 26 and accessible by causes 24 and sponsors 12, as well as donors/customers 20. A series of buttons 70 including areas of interest 72, charity link 74, sponsor/business link 76, cause/organization link 78, about service 80, and contact service 82. Also, a search function 84 may be provided to facilitate a visitor's use of the web site. A series of page tabs 86, including participating charities 88, participating organizations 90, participating businesses 92, donor testimonials 94, and donor benefit/issues 96, are provided to aid the visitor in browsing the site. Further, links to particular items of interest, such as highlights featuring a selected campaign of the month, sponsor of the month, charity of the month, cause of the month, donor benefits, or the like, may be provided for the benefit of the visitor and to enhance interest in the web site. Access to certain areas of the web site may be restricted and may require registration, the use of passwords, or other forms of verified entry, for visitors to gain access to that area. For example, one area of the web site may be dedicated to participating sponsors/businesses, wherein such businesses may be permitted to examine tracking of donations, interests, hits, etc. related to one or more hosted fundraising campaigns. Also, an interested sponsor/business may be provided with access to information concerning causes of interest to users and use such information in forming a relationship to establish a fundraising campaign.

Another area of the web site may be dedicated to participating causes or organizations for tracking information related to particular fundraising campaigns and for investigating existing or prospective hosts. An area of benefit to potential donors is donor benefits issues area 96, which would include items of interest such as tax benefits associated with donations, qualified organizations, financial tools, e.g., to help quantify tax benefits associated with a given donation and contrast benefits associated with respective contributions or investments, ratings associated with particular causes or charities including such things as ratio of donation dollar deliverable to cause beneficiaries, etc.

At the fundraising campaign service provider web page of FIG. 20, prospective sponsors may research causes and may request the service provider 26 to establish a connection with a selected cause to explore the possibility of hosting a fundraising campaign at the host sponsor site. The service provider 26 may employ questionnaires to prompt responses from host or causes relating to campaign parameters which may facilitate the research process, for example, start/end dates of proposed fundraising campaign, goals (number of donors, dollar amount by stages, etc.), type of product/service to be associated with a particular campaign, type of donor information desired, donor reward structure (points, discount off product price, cashback, matching donations, coupons, etc.). Further, a cause, especially large national organizations or charities, may establish multiple levels of sponsors, such as gold, silver and bronze, wherein each sponsorship level involves varying levels of marketing exposure during a fundraising campaign and imposing different requirements upon the host sponsors. In fact, a particular donation or fee may be associated with permitting a sponsor to host a given fundraising campaign on behalf of a particular cause or charity.

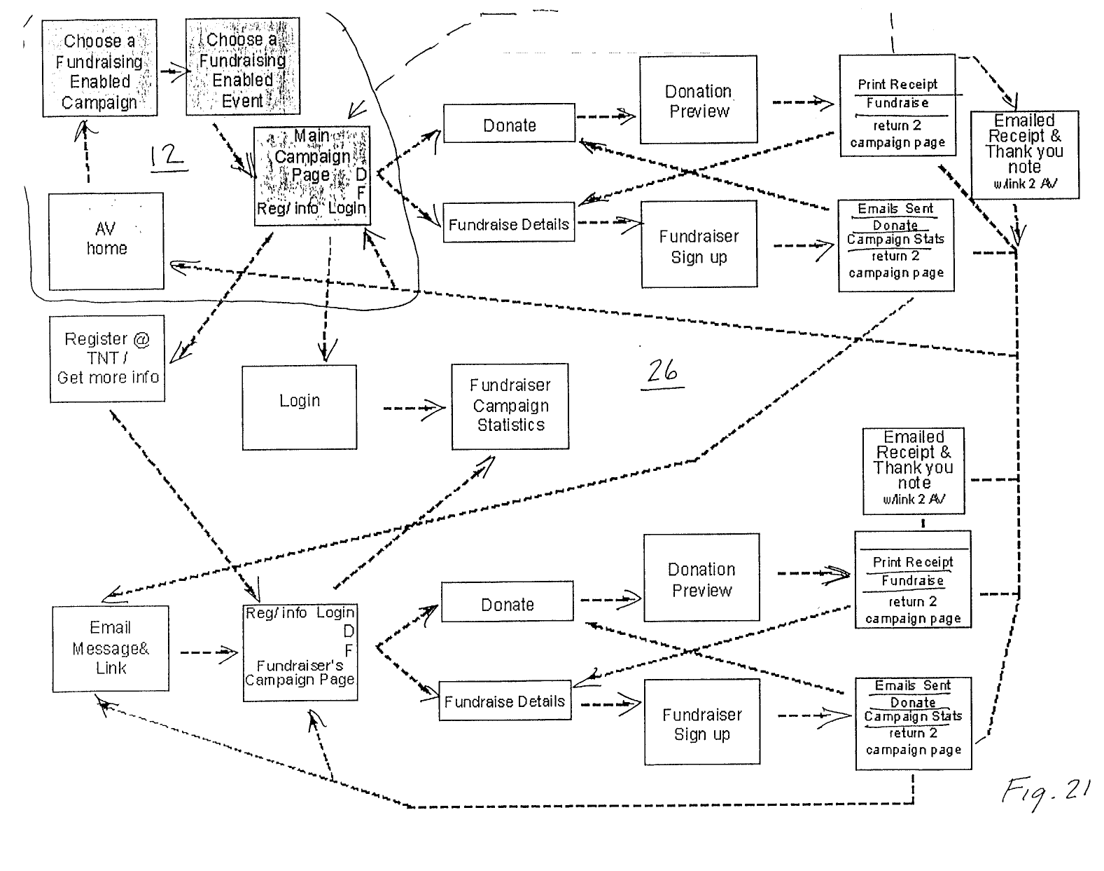

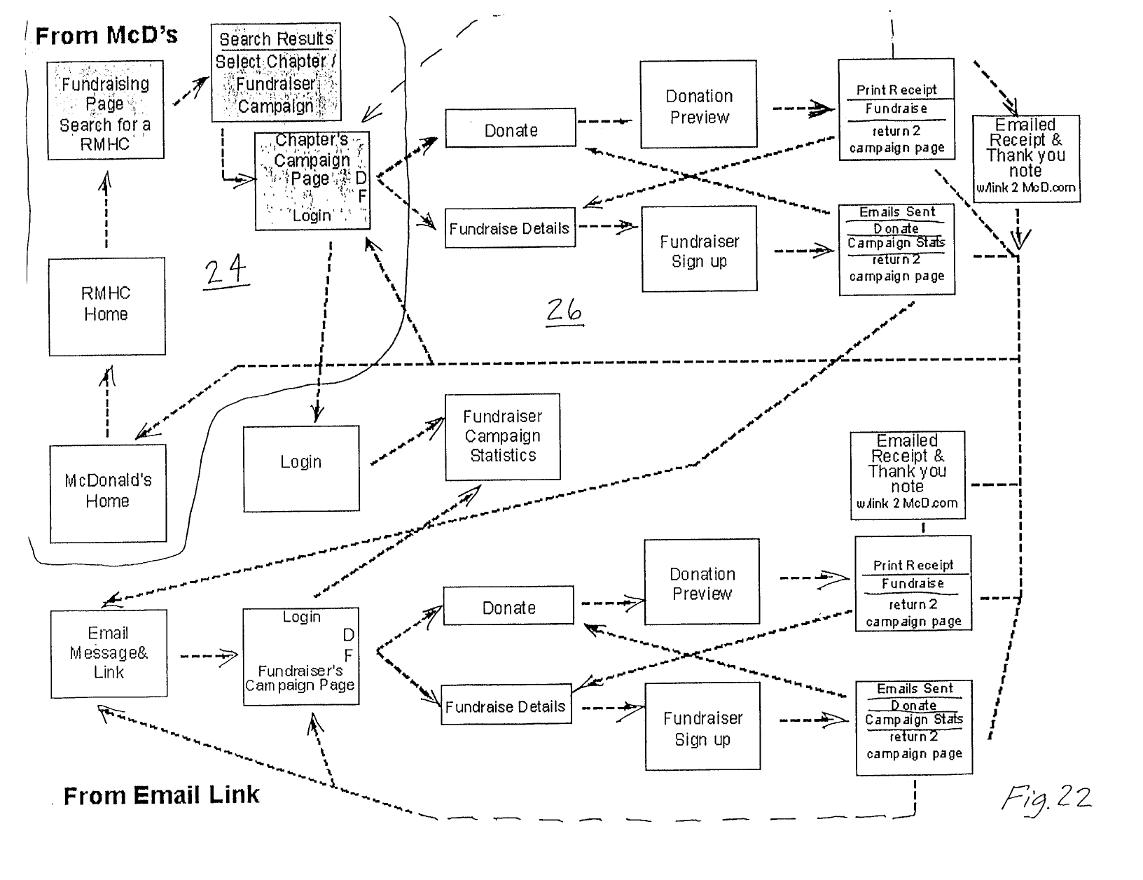

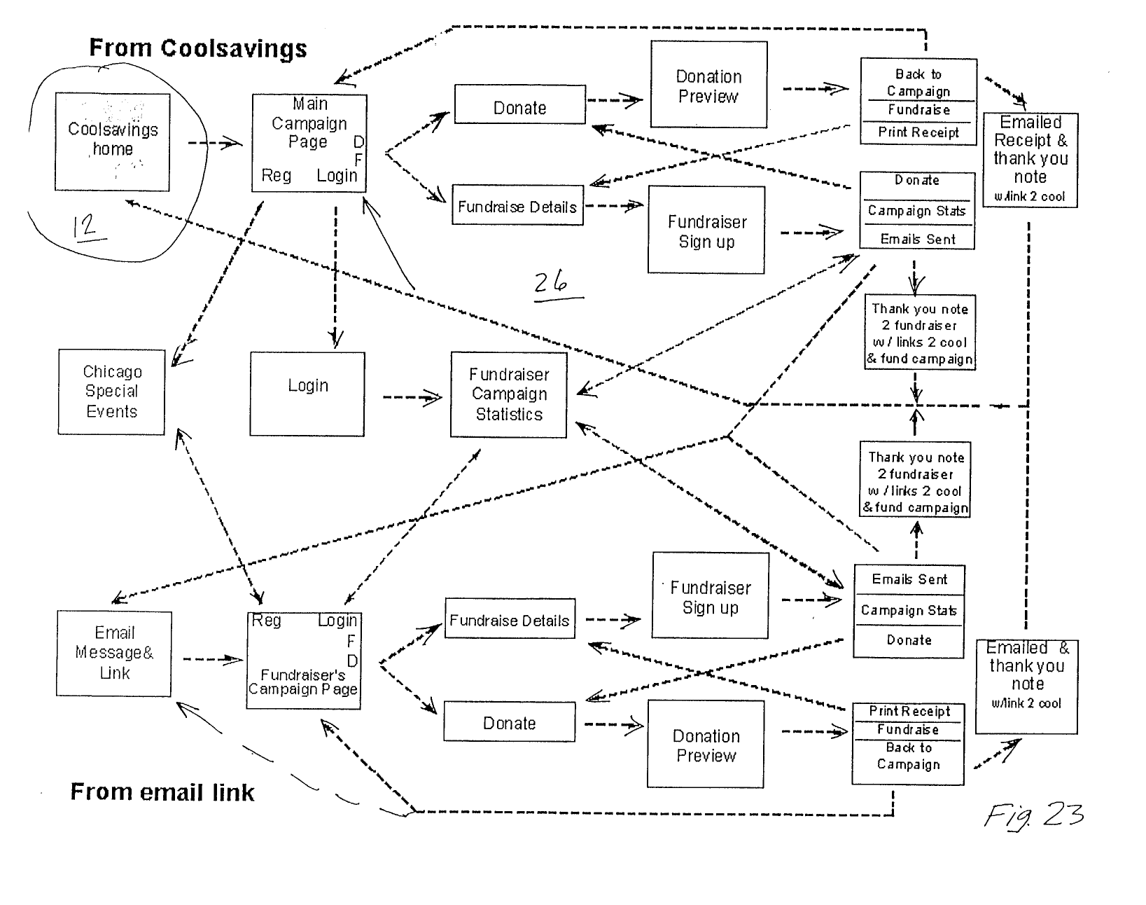

FIGS. 21 and 23 are flow charts illustrating potential flow paths within online fundraising systems wherein a user may first access webpages of a host business/sponsor site 12 having various pages and functions differentiated by shading. From the host site the user may be redirected or rerouted in the seamless fashion described hereinabove to the online fundraising service provider 26 and access various other pages and functions upon logging into the system. The various pages and functions shown in the figures are representative of the overall fundraising system and additional pages comprising different related functions may be provided as desired to customize the fundraising campaign and to achieve other related objectives that are fully contemplated by the present invention. FIG. 22 likewise is a flow chart illustrating potential flow paths within an online fundraising system wherein a user may accesses webpages of the cause site 24 having various pages and functions differentiated by shading. The manner of operation is essentially the same whether the business 12 or the cause 24 functions as the host for the fundraising campaign.

In another embodiment, the fundraising campaign system and method of the present invention may be implemented in a portal fashion, whereby a particular sponsor/business, such as e-campus.com, offers a set of products or services to a particular community, such as textbooks and supplies to college students, and the sponsor provides its customers, such as students or student-run organizations, with the ability to set up a fundraising campaign. This system enables fund-raisers to create individual dedicated fundraising campaign pages for particular organizations, for instance, fraternities, athletic teams, etc. In this manner, individual students or groups of students or the like may set up a dedicated the fundraising campaign to send email messages to identified recipients to request donations or other assistance in conjunction with a particular cause or event.

In this manner, the business/host is able to attract its customers to its site for the purpose of using the fundraising system for a particular cause, even though the business/host is not associated with the particular cause or any other cause. This method of using the fundraising system may be referred to as the “Product Enhancement Benefit” method, as opposed to the “Participatory Marketing” method. How a company uses the fundraising system largely depends on the type of business and the nature of the its relationship with its customers. Many businesses, e.g., portals such as Yahoo, Excite, Ivillage, etc., may employ fundraising system in both models to boost direct product sales and to help build and sustain brand awareness.

In another embodiment, a web site dedicated to a particular class or area of interest, such as sports, may relate to an identifiable community of customers/visitors, e.g., runners, golfers, tennis players, etc. The fundraising system of the present invention empowers groups within such communities to employ the fundraising campaign system by associating particular events, such as sporting events, with particular causes to assist fundraising efforts.

Other embodiments and uses of the invention will be apparent to those skilled in the art from consideration of the specification and practice of the invention disclosed herein. The specification and examples should be considered exemplary only and do not limit the intended scope of the invention. The examples of fundraising campaigns discussed, illustrated and referred to herein, such as the sample Coolsavings and MVP.com screen shots, are not “live” active campaigns, although they may be in the future, and are included merely to assist the reader in understanding the technology of the invention.

What is claimed is:

1. A method for enabling a business entity to raise funds and awareness for a fundraising entity over a distributed network, comprising the steps of:
enabling the business entity to identify at least one fundraising entity;
hosting one or more fundraising events associated with the fundraising entity; and
providing interactive participation between at least one user and the fundraising entity.

2. The method of claim 1 wherein the distributed network comprises an email network.

3. The method of claim 1 wherein the step of hosting one or more fundraising events further comprises a step of sending at least one request for support for the fundraising entity through electronic messages to one or more identified recipients.

4. The method of claim 1 wherein the step of hosting one or more fundraising events further comprises a step of providing at least one promotional message on a user interface associated with the business entity.

5. The method of claim 1 wherein the step of providing interactive participation further comprises a step of providing at least one incentive to motivate the at least one user to contribute to the fundraising entity.
